(19) United States
(12) Patent Application Publication
(10) Pub. No.: US 2009/0237026 A1
(43) Pub. Date: Sep. 24, 2009

(54) System and Method for Drive Controller Anti-Backlash Control Topology

(75) Inventors: Razvan Panaitescu, Alpharetta, GA (US); Markus Geyer, Hessdorf (DE); Jose Mendez, Sugar Hill, GA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Energy & Automation, Inc., Alpharetta, GA (US)

(21) Appl. No.: 12/370,622

(22) Filed: Feb. 13, 2009

Related U.S. Application Data
(60) Provisional application No. 61/037,581, filed on Mar. 18, 2008.

(51) Int. Cl. G05B 11/36; F16H 55/18

(52) U.S. Cl. 318/630; 74/409

(57) ABSTRACT

Method and system for backlash control in gear trains that are driven by electric drives controlled by a drive controller. The drive controller causes the drives to generate continuously opposing torques and adjusts torque rotational offsets so as to maintain desired backlash and gross motion of the driven gear.

### CLAIM TO PRIORITY

This application claims the benefit of co-pending United States provisional patent application entitled “System And Method For Anti-Backlash Control Topology For Use With Drives” filed Mar. 18, 2008 and assigned Ser. No. 61/037,581, which is incorporated by reference herein.

### BACKGROUND OF THE DISCLOSURE

1. Field of the Invention

The invention relates to electric drive controllers for controlling electric drives, and particularly a method and system for backlash control in motion-reversing gear trains driven by electric drives. The drive controller of the present invention provides for backlash control in gear trains that are driven by at least a pair of first and second drives without the need for external or auxiliary electro-pneumatic or electro-mechanical gear tensioners or preloaders.

The present invention is suitable for high or variable load transport applications that require ability to change motion direction, such as by way of non-limiting example precision handling cranes, drag lines and winches. Such load transport mechanical systems employ direction-reversing gear trains powered by one or more electric drives. The electric drives are controlled by a drive controller. The electric drive is coupled to a driving gear of the gear train that in turn is capable of moving one or more driven gears.

2. Description of the Prior Art

Typical gear trains include at least one driving gear and at least one driven gear coupled to each other in series, in parallel or a combination of both. Gear trains may be constructed to provide rotary or linear gross motion or a combination of both. Gears in a gear train may be coupled directly (i.e., tooth-to-tooth contact) or through intermediate linear drive elements, such as belts or chains.

Meshing gears generally have gap, called a backlash, between opposing teeth surfaces, resulting from, among other things, gear element machining variances, operational wear, compensation for thermal expansion and gear element deformation under varying loads. Backlash, especially when multiple serial or parallel gear elements in the gear train are interacting, reduce predictability and precision in gear train motion and cause a phase delay in motion response. In order to transfer motion from a driving gear element to a driven gear element the backlash must be taken up so as to allow direct contact between the respective gear element (or intermediate linear drive element) tooth surfaces.

In the past, backlash take-up has been accomplished by fitting gear trains with external or auxiliary gear tensioners or preload devices that bias the respective gear element teeth in direct contact with each other. The biasing elements commonly have employed mechanical springs, pressurized fluid cylinders or suspended weights. Such auxiliary tensioners add additional mechanical complexity and expense to a gear train.

Other backlash take-up solutions have been proposed in the past, primarily for machine tool motion control applications, to use a pair of opposed-motion electric drives interacting on a set of driving/driven gears or on a ball screw drive element. Generally such solutions have employed electric drives capable of self-reversing motion, i.e., each drive being able to rotate under power in either clockwise or counter-clockwise direction to take up backlash and then mutual cooperation to move the gear train or ball screw assembly in the desired motion direction.

In such machine tool motion control applications the drive controller separately controls motor speed or phase in a pair of drives that, through driven gears or ball screws, momentarily cause driven gear motion in opposing directions to take up backlash. Thereafter the pair of drives cooperate to move the driven gear in the desired direction of motion. When utilizing phase or speed control backlash take-up, a first drive motor will be driven at a desired speed or phase angle position and the second drive motor will be driven at a slower speed or different phase angle position so that each drive gear effectively pretensions the corresponding driven gear or screw. Generally, driving two drive motors at different speeds for a set time period to pretension drive and driven gears, then coordinating rotation in a common direction is not as precise as phase angle control. Matching the desired variable speeds to have sufficient dwell time to take up backlash, but not so much as to generate large opposing counter forces in the counter-rotating drives becomes an educated guess for setting control parameters in the drive controller. The prior alternative solution of precise phase angle control and feedback sensors may not be suitable for some heavy-load transmission construction and mining applications as compared to a relatively clean environment factory floor normally encountered in machine tool motion control applications. A machine screw backlash take-up utilizing independently-reversible ball screw drive motors with torque-controlled ball screw pretension for part of an operating cycle has been proposed in the past.

In the previously proposed backlash-take-up by counter-rotating drives solutions primarily for machine tool motion control applications, the independent drives then have coordinated rotations to cause desired translation of the driven gear. After initial pretensioning, translation of the driven gear in the desired direction is then accomplished by powering both drive motors in the same rotational direction. Generally such self-reversible drives for motion control applications are not suitable for the much higher load applications demanded by precision cranes, drag lines, winches or the like. In such high-load applications it is preferable to have a drive dedicated to rotation in a single direction. By way of example, a first drive causes motion of a driven gear in a first rotational direction and a second drive causes motion of the driven gear in the opposite rotational direction. In a precision crane application, the first motor may cause the gear train to lift the load and the second motor may cause the gear train to lower the load.

Thus, a need exists in the art for a method and system to control gear backlash in an application having a pair of drives that are always powered in opposite rotational directions, without the need for auxiliary gear pretensioning systems.

### SUMMARY OF THE INVENTION

Accordingly, an object of the invention is to control gear backlash in a gear train, without the need for separate gear tensioners or preloader apparatus.

These and other objects are achieved by the method and system of the present invention, for backlash control in gear trains that are driven by electric drives controlled by a drive controller. The drive controller causes the drives to generate continuously opposing torques and adjusts torque rotational offsets so as to maintain desired backlash torque and gross motion of the driven gear.

One aspect of the present invention is directed to a method for operating a drive controller to control gear backlash in a gear train having at least a pair of first and second driving gears and at least one commonly driven gear, the driving gears being powered by respective first and second drives that are coupled to the drive controller, comprising simultaneously powering the first drive to cause first gear rotation only in a first positive rotational direction and the second drive to cause second gear rotation only in an opposite negative rotational direction, selectively varying the respective drive torque outputs with the drive controller in order to generate continuously opposing rotational torques and adjusting torque rotational offsets so as to maintain desired backlash torque among the respective gears during driven operation of the gear train and desired gross motion of the driven gear.

Another aspect of the present invention is directed to a drive controller adapted to couple to at least one pair of first and second drives that are in turn coupled to respective first and second driving gears that form a gear train with at least one commonly driven gear, the drive controller comprising circuitry that simultaneously powers the first drive to cause first gear rotation only in a first positive rotational direction and the second drive to cause second gear rotation only in an opposite negative rotational direction, selectively varies drive torque outputs of the respective first and second drives so that they generate continuously opposing rotational torques and that adjusts torque rotational offsets, so as to maintain desired backlash torque among the respective gears during driven operation of the gear train and desired gross motion of the driven gear.

An additional aspect of the present invention is directed to a gear train backlash control system comprising a gear train having at least a pair of first and second driving gears and at least one commonly driven gear, with first and second drives coupled to the respective first and second driving gears. A drive controller is coupled to the first and second drives, having circuitry that simultaneously powers the first drive to cause first gear rotation only in a first positive rotational direction and the second drive to cause second gear rotation only in an opposite negative rotational direction. The drive controller selectively varies drive torque outputs of the respective first and second drives, so that they generate continuously opposing rotational torques. The drive controller adjusts torque rotational offsets, so as to maintain desired backlash torque among the respective gears and gross motion of the driven gear during driven operation of the gear train.

The present invention is also directed to drive controller software code stored in an electronic storage medium that when run by a processor of the drive controller enables the drive controller to control gear backlash in a gear train having at least a pair of first and second driving gears and at least one commonly driven gear, where the driving gears are powered by respective first and second drives that are coupled to the drive controller. The software run by the processor enables the drive controller to power simultaneously the first drive to cause first gear rotation only in a first positive rotational direction and the second drive to cause second gear rotation only in an opposite negative rotational direction. The drive controller running the software code selectively varies the respective drive torque outputs in order to generate continuously opposing rotational torques and adjusts torque rotational offsets so as to maintain desired backlash torque and gross motion among the respective gears during driven operation of the gear train.

### BRIEF DESCRIPTION OF THE DRAWINGS

The teachings of the present invention can be readily understood by considering the following detailed description in conjunction with the accompanying drawings, in which:

FIG. 1 is a schematic perspective view of the backlash control system of the present invention, as applied to a rotary-motion gear train;

FIG. 2 is a schematic perspective view of the backlash control system of the present invention, as applied to a linear-motion gear train;

FIG. 3 is a schematic perspective view of the backlash control system of the present invention, as applied to a gear train including linear drive elements, such as cogged belts or chains;

FIG. 4 is a block diagram of the drive controller architecture of the present invention;

FIG. 5 is a block diagram of the drive controller control topology; and

FIG. 6 is an exemplary operational speed and torque profile diagram of the backlash control system of the present invention.

To facilitate understanding, identical reference numerals have been used, where possible, to designate identical elements that are common to the figures.

### DETAILED DESCRIPTION

After considering the following description, those skilled in the art will clearly realize that the teachings of the invention can be readily utilized in making and using the backlash control system of the present invention.

General System Description

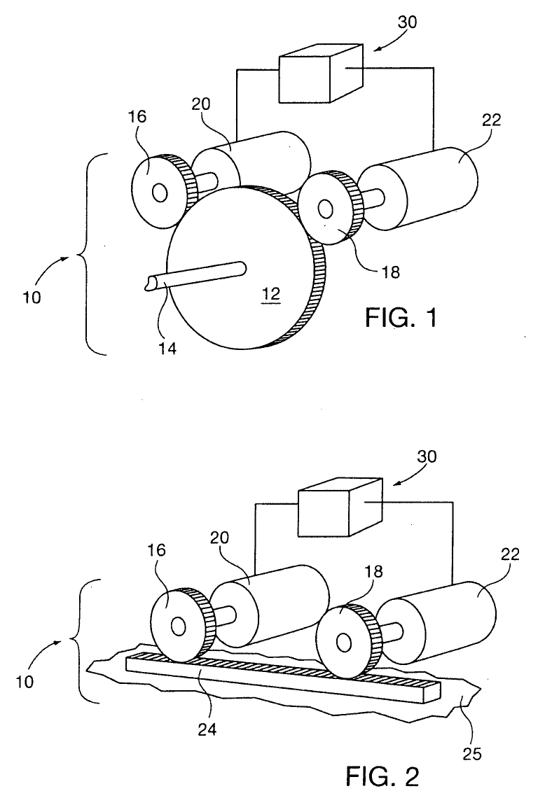

Referring to FIG. 1, a rotary gear train 10 is shown in simple schematic form, having a driven gear 12 that is coupled to a shaft 14. It is understood by those skilled in the art that the shaft 14 depicts one of many ways to generate useful output work from the gear train, for example to drive a cable winch for raising and lowering loads in a precision crane (not shown). Driven gear 12 is driven by a pair of first and second driving gears, 16, 18. In FIG. 1 the gears 12, 16, 18 are shown as simple pinion gears for exemplary purposes. As one skilled in the art will appreciate, gear trains can comprise multiple gears arrayed in series, in parallel or a combination of both. In application, gears functioning as the driving gears or the driven gears may comprise multiple gears.

As shown in FIG. 1, the first driving gear 16 is coupled to and powered by first drive 20, an electric motor. The electric motor, by way of example, may be an induction motor in vector-control with a speed control loop or in direct torque control with speed monitoring, a reluctance motor in speed and torque control mode or a permanent magnet motor in speed control mode. Likewise, the second driving gear 18 is powered by second drive 22. While one exemplary pair of driving gears 16, 18 and drives 20, 22 are shown in FIG. 1, it should be understood that multiple pairs of driving gears and drives can be utilized to drive the gear train 10, and the single driven gear 12 can comprise a series of gears, such as a planetary gear array (not shown). When applying the present invention, gears in a gear train need not be restricted to rotary motion or direct tooth-to-tooth driving applications.

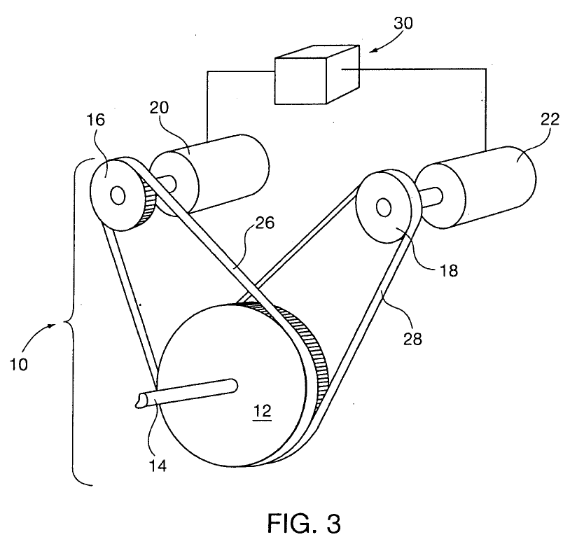

For example, FIG. 2. shows a schematic representation of a rack and pinion linear drive system 10 that includes driving gears 16, 18 powered by respective drives 20, 22 similar to the system shown in FIG. 1. In FIG. 2 the driven gear is a linear-motion rack 24 that is coupled to a table 25. In FIG. 3, the gear train 10 includes exemplary linear drive element cogged drive belts 26, 28 intermediate the respective driving gears 16, 18 and driven gear 12. As one can appreciate other direct contact surface to contact surface drive elements can be substituted for toothed gears and/or belts, such as chains and toothed sprockets (not shown).

Referring generally to all of the system embodiments shown in FIGS. 1-3, the first and second drives 20, 22 are powered by an electric power source. Drive controller 30 separately controls electric power application to the first and second drives 20, 22, enabling the drives to impart mechanical motion to the respective driving gears 16, 18, and they in turn to the driven gear 12. Thus, through the drive controller 30 selectively varying power application to the drives 16, 18 the output driven gear 12 speed, direction of motion and output power can be selectively varied. As will be explained below in the operational description of the present invention, gear train 10 backlash and ultimate driven gear motion is selectively controlled by the drive controller 30.

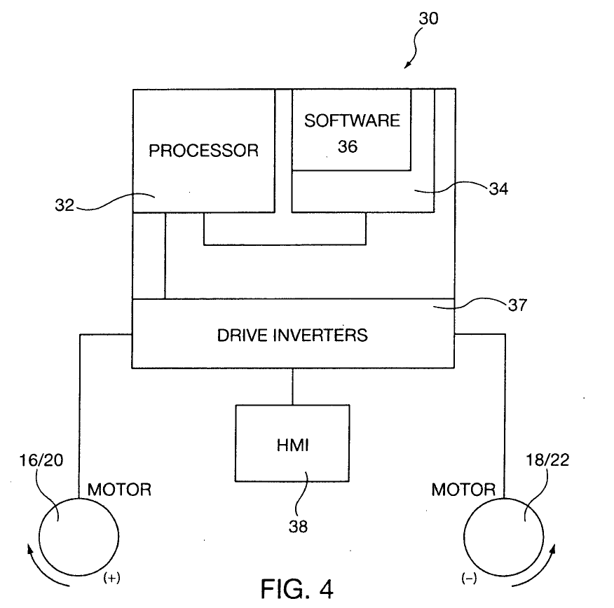

As shown in FIG. 4, drive controller 30 preferably has at least one processor 32 that is coupled to memory 34 capable of storing software code 36 that is executable by the processor. The processor controls the drive inverter system 37 that in turn powers the gears/drives 16/20 and 18/22 The drive controller 30 preferably has at least selective connection to a human-machine interface (HMI) 38, for example allowing an operator to specify operational parameters and/or monitor system operational performance. The HMI 38 or other communication systems, not shown, may also allow communication of the drive controller 30 to automation systems via a fixed or wireless communications network employing any communications protocol, including Internet protocols. Communication to and/or from the drive controller 30 enables remote operation, monitoring and reconfiguration, i.e., modifying software code stored in memory 34 and run by the processor 32.

An exemplary drive controller 30 suitable for use in the present invention is the SINAMICS® drive controller family and torque-control operational software sold in the United States by Siemens Energy & Automation, Inc. of Alpharetta, Ga., Internet website URL www.sea.siemens.com, though it should be understood that other drive controllers should be capable of being programmed to perform the gear train backlash control system and method of the present invention. In the following description, some control parameter reference designators may be those customarily used by those skilled in the art who are familiar with SINAMICS® brand drive controllers, but it should be understood that other manufacturers use other reference designations for the same control parameters in their product literature. While drive controller functions in the embodiments described herein are performed in a programmable electronic drive controller, one skilled in the art can appreciate that the operational control functions described below can be accomplished in an electro-mechanical control device or control relay employing electro-mechanical relays, dedicated-use processors, analog electronic relays, firmware controls and the like.

System Operational Description

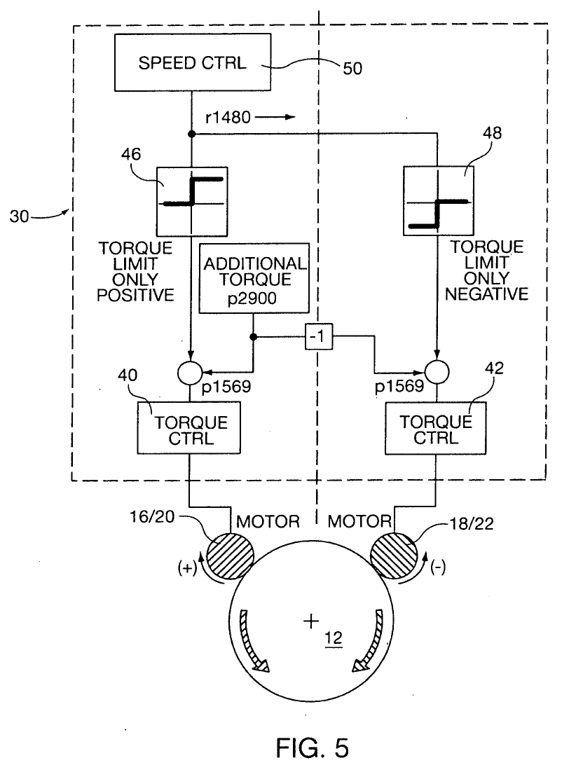

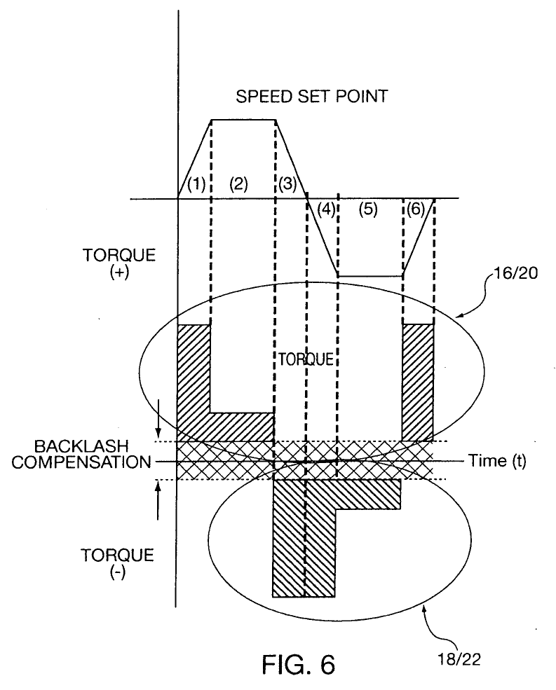

Exemplary system operation is now described, with reference to the control topology block diagram, FIG. 5 and operational speed and torque profile diagram, FIG. 6. FIG. 5 shows that driven gear 12 is capable of clockwise or counter-clockwise desired gross motion through application of the first and second driving gears 16, 18. For simplicity in understanding of FIG. 5, the respective first and second drive motors corresponding to the first driving gear 16 and second driving gear 18 are not shown, it being understood that reference to motor means a corresponding reference to the driving gear shown in the figure.

In the operating embodiments of the present invention described below, the drive controller 30 restricts first drive motor operation to clockwise rotation by application of only positive torque in the Torque CTRL 40. Thus it follows that counterclockwise rotation of the driven gear 12 is generated by first drive motor and corresponding drive gear 16. Similarly the drive controller 30 restricts second drive motor operation to counter-clockwise rotation by application of only negative torque in Torque CTRL 42. It then follows that clockwise rotation of the driven gear 12 is generated by the second drive and corresponding drive gear 18.

Referring again to FIG. 5, in order to control gear train 10 backlash, first and second drive gears 16, 18 preferably are powered in their respective positive and negative torque directions by application of equal absolute torque at the Additional Torque functional control block p2900 that feeds a positive torque command p1569 to Torque CTRL 40 and a corresponding negative torque command p1569 to Torque CTRL 42. In this manner gear teeth backlash is taken up between the respective gears 12, 16 and 18, and the driven gear 12, if desired, can be maintained in a stationary or neutral rotational position. In some applications applying constant equal and opposite torque may not be necessary to eliminate backlash under all operating conditions. It is again noted that the p2900 and p1569 designations are commonly used in SINAMIC® brand drive controller literature, and that other manufacturers use different designations in their literature.

When it is desired to cause operational rotational movement of driven gear 12, such as to raise or lower a precision crane payload (not shown), as described in further detail below, the drive controller 30 through the respective Torque CTRL functions 40, 42 generates offsetting positive and negative torques on the driven gear 12. All drive control preferably is effectuated through torque control. Desirably, torque control is further refined via known torque sensing feedback loops coupled to the drive controller 30, so that torque outputs generated by each of the drives powering the driving gears 16, 18 is sensed by and is varied at least partially based on the sensed torque outputs. In this manner the differential between desired and sensed torque outputs is reduced.

As shown in FIG. 5, it is desirable to have the first and second drive gears 16, 18 and their drives controlled from the same drive controller that is capable of simultaneously controlling two drive axes and minimizing communication time between them. In this exemplary embodiment, first motor and drive gear 16 is speed controlled and the second motor and drive gear 18 is only torque controlled. As discussed above, the Torque Limit 46 is only positive for the first motor/drive gear 16 and Torque Limit 48 is only negative for the second motor/drive gear 18. Rotational speed and direction of the driven gear 12 are specified by the output of the Speed CTRL 50, which converts the desired rotational speed and direction to positive or negative torque commands r1480, that preferably are at least partially based on first drive/gear 16 speed. Desirably the drive controller 30 speed set point is compared with the actual speed sensed in motor/drive gear 16 via a known feedback loop. It follows that first motor/drive gear 16 only responds to positive torque commands and, correspondingly, second motor/drive gear 18 only responds to negative torque commands. Additional Torque p2900 commands are fed to the respective Torque CTRL 40, 42 apparatus, thus generating overall cumulative offsetting torque commands to each of their respective first and second motor/drive gear pairs 16, 18.

An exemplary inter-relationship between speed and torque set points in the respective first and second motor/drive gear 16, 18 pairs during acceleration, achievement of constant rotational speed, and reversal of rotational speed is shown in FIG. 6. During operational periods (1), (2) and (3), driven gear 12 speed has a counter-clockwise (CCW) direction, while during the (4), (5) and (6) periods the drive gear 12 speed is clockwise (CW). At all times both electric motor drives 20, 22 are commanded to develop an Additional Torque p2900. This p2900 torque value is represented in the torque profile graph of FIG. 6 by a dashed line and also as a cross-hatch when it overlaps with other commanded torque values on each of motor drives 20, 22.

During the acceleration time period (1) the first gear 16/motor drive 20 takes control and develops the inertial torque necessary to accelerate driven gear 12. The inertial torque is added on top of the already present backlash compensation torque p2900.

At constant counter-clockwise speed shown in time period (2) the first gear 16/motor drive 20 is producing enough torque to compensate for the backlash counter-torque generated by gear 18/motor drive 22, any mechanical power dissipation losses in the driven system, such as friction, and any load oscillations on the driven gear 12. In this mode of operation the gear 16/motor drive 20 is generating sufficient power necessary to maintain the desired system steady state.

Time period (3) of the motion profile refers to a deceleration. If the present invention were not practiced during deceleration, first drive/drive gear 16/20 normally should be commanded to brake the motion, because the speed controller output is a negative value. However, the drive control topology of the present invention has the two torque limitation blocks 46, 48 that prevent the torque in first drive/drive gear 16/20 to go negative and conversely prevents the second drive/drive gear 18/22 to go positive. During the operational period (3) deceleration, the second drive/drive gear 18/22 takes control of the motion and in fact accelerates the motion of driven gear 12 towards the clockwise direction.

The torque profile repeats in opposite direction during operational time periods (4), (5) and (6) with second drive/drive gear 18/22 being now the main actor in producing the motion of the driven gear 12. It should be noted that the exemplary torque profile shown in FIG. 6 is for an equal and opposite magnitude oscillating directional load. In other applications the torque profile will vary in direction, magnitude, acceleration and time periods.

Over the whole speed profile, the first and second drive motors 20, 22 are controlled to develop an opposing torque which in fact is keeping the teeth of the respective drive and driven gears 12, 16, 18 from losing direct contact and thus eliminating gear train backlash from the system.

Although various exemplary embodiments which incorporate the teachings of the present invention have been shown and described in detail herein, those skilled in the art can readily devise many other varied embodiments that still incorporate these teachings. Accordingly, it is intended that the scope of the present be defined by the accompanying claims given their broadest interpretation allowable by law, rather than being limited by the exemplary embodiments described above that are intended to help those skilled in the art understand how to make and use the subject invention.

What is claimed is:

1. A method for operating a drive controller to control gear backlash in a gear train having at least a pair of first and second driving gears and at least one commonly driven gear, the driving gears being powered by respective first and second drives that are coupled to the drive controller, comprising simultaneously powering the first drive to cause first gear torque generation only in a first positive rotational direction and the second drive to cause second gear torque generation only in an opposite negative rotational direction, selectively varying the respective drive torque outputs with the drive controller in order to generate continuously opposing rotational torques and adjusting torque rotational offsets so as to maintain desired backlash torque among the respective gears during driven operation of the gear train and desired gross motion of the driven gear.

2. The method of claim 1 wherein the drive controller adjusts torque rotational offsets by maintaining generally constant additional opposing backlash torque on both drives during their operation.

3. The method of claim 2 further comprising controlling speed of the first drive with the drive controller and varying the respective torque outputs at least partially based on the first drive speed.

4. The method of claim 1 further comprising controlling speed of the first drive with the drive controller and varying the respective torque outputs at least partially based on the first drive speed.

5. The method of claim 1 further comprising sensing torque generated by the first and second drives and varying their respective generated drive torque at least partially based on the sensed torque.

6. The method of claim 1 further comprising:
controlling speed of the first drive with the drive controller and varying the respective torque outputs at least partially based on the first drive speed;
limiting respective torque generation output in the first drive only to a positive rotational direction and in the second drive only to an opposite negative rotational direction;
sensing torque generated by the first and second drives and varying their respective generated drive torque in a feedback loop at least partially based on the sensed torque; and
the drive controller adjusting torque rotational offsets by maintaining generally constant additional opposing backlash torque on both drives during their operation.

7. A drive controller adapted to couple to at least one pair of first and second drives that are in turn coupled to respective first and second driving gears that form a gear train with at least one commonly driven gear, the drive controller comprising circuitry that simultaneously powers the first drive to cause first gear torque generation only in a first positive rotational direction and the second drive to cause second gear torque generation only in an opposite negative rotational direction, selectively varies drive torque outputs of the respective first and second drives so that they generate continuously opposing rotational torques and that adjusts torque rotational offsets, so as to maintain desired backlash torque among the respective gears during driven operation of the gear train and desired gross motion of the driven gear.

8. The drive controller of claim 7, wherein the circuitry maintains generally constant additional opposing backlash torque on both drives during their operation.

9. The drive controller of claim 7, wherein the circuitry limits respective torque generation output in the first drive only to a positive rotational direction and in the second drive only to an opposite negative rotational direction.

10. The drive controller of claim 7, wherein the circuitry controls speed of the first drive and varies the respective generated torque outputs at least partially based on the first drive speed.

11. The drive controller of claim 7, wherein the circuitry senses torque generated by the first and second drives and varies their respective drive torque at least partially based on the sensed torque.

12. The drive controller of claim 7, further comprising:
the circuitry controlling speed of the first drive and varying the respective torque outputs at least partially based on the first drive speed;
the circuitry limiting respective torque generation output in the first drive only to a positive rotational direction and in the second drive only to an opposite negative rotational direction;
the circuitry sensing torque generated by the first and second drives and varying their respective generated drive torque in a feedback loop at least partially based on the sensed torque; and
the circuitry adjusting torque rotational offsets by maintaining generally constant additional opposing backlash torque on both drives during their operation.

13. A gear train backlash control system comprising:
a gear train having at least a pair of first and second driving gears and at least one commonly driven gear;
first and second drives coupled to the respective first and second driving gears; and
a drive controller coupled to the first and second drives, having circuitry that simultaneously powers the first drive to cause first gear torque generation only in a first positive rotational direction and the second drive to cause second gear torque generation only in an opposite negative rotational direction, selectively varies drive torque outputs of the respective first and second drives, so that they generate continuously opposing rotational torques and that adjusts torque rotational offsets, so as to maintain desired backlash torque among the respective gears during driven operation of the gear train and desired gross motion of the driven gear.

14. The system of claim 13, wherein the circuitry maintains generally constant additional opposing backlash torque on both drives during their operation.

15. The system of claim 13, wherein the circuitry limits respective torque generation output in the first drive only to a positive rotational direction and in the second drive only to an opposite negative rotational direction.

16. The system of claim 13, wherein the circuitry controls speed of the first drive and varies the respective generated torque outputs at least partially based on the first drive speed.

17. The system of claim 13, wherein the circuitry senses torque generated by the first and second drives and varies their respective drive torque at least partially based on the sensed torque.

18. The system of claim 13, further comprising:
the circuitry controlling speed of the first drive and varying the respective torque outputs at least partially based on the first drive speed;
the circuitry limiting respective torque generation output in the first drive only to a positive rotational direction and in the second drive only to an opposite negative rotational direction;
the circuitry sensing torque generated by the first and second drives and varying their respective generated drive torque in a feedback loop at least partially based on the sensed torque; and
the circuitry adjusting torque rotational offsets by maintaining generally constant additional opposing backlash torque on both drives during their operation.

19. An electronic storage medium storing a computer program comprising software code portions that when run by a processor of a drive controller enables the drive controller to control gear backlash in a gear train having at least a pair of first and second driving gears and at least one commonly driven gear, the driving gears being powered by respective first and second drives that are coupled to the drive controller, comprising simultaneously powering the first drive to cause first gear torque generation only in a first positive rotational direction and the second drive to cause second gear torque generation only in an opposite negative rotational direction, selectively varying the respective drive torque outputs with the drive controller in order to generate continuously opposing rotational torques and adjusting torque rotational offsets so as to maintain desired backlash among the respective gears during driven operation of the gear train and desired gross motion of the driven gear.

20. The storage medium of claim 19, the software code therein when run by the processor further enabling drive controller functions comprising:
controlling speed of the first drive with the drive controller and varying the respective torque outputs at least partially based on the first drive speed;
limiting respective torque generation output in the first drive only to a positive rotational direction and in the second drive only to an opposite negative rotational direction;
sensing torque generated by the first and second drives and varying their respective drive torque in a feedback loop at least partially based on the sensed torque; and the drive controller adjusting torque rotational offsets by maintaining constant additional opposing backlash torque on both drives during their operation.
